(19) United States
(12) Patent Application Publication
(10) Pub. No.: US 2017/0155285 A1
(43) Pub. Date: Jun. 1, 2017

(54) OPEN TYPE RESONANCE COIL WITHOUT DUAL LOOPS HAVING SERIAL TYPE IN-PHASE DIRECT POWER FEEDING METHOD WITHOUT DUAL LOOPS

(71) Applicant: Electronics and Telecommunications Research Institute, Daejeon (KR)

(72) Inventors: Je Hoon YUN, Daejeon (KR); Seong Min KIM, Daejeon (KR); Jung Ick MOON, Daejeon (KR); Duk Ju AHN, Daejeon (KR); Sang Bong JEON, Daejeon (KR); In Kui CHO, Daejeon (KR)

(73) Assignee: Electronics and Telecommunications Research Institute, Daejeon (KR)

(21) Appl. No.: 15/364,443

(22) Filed: Nov. 30, 2016

(30) Foreign Application Priority Data
Nov. 30, 2015 (KR) 10-2015-0169408
Oct. 31, 2016 (KR) 10-2016-0143583

(51) Int. Cl. H02J 50/12; H02J 50/90; H02J 50/20

(52) U.S. Cl. CPC H02J 50/12; H02J 50/20; H02J 50/90

(57) ABSTRACT

An open type resonance coil without dual loops having a serial type in-phase direct power feeding method without dual loops is provided. A transmission device is configured as two resonators and to feed power in phase, the transmission device is configured as a power feeding loop without a resonance coil, two transmission devices are connected in series, and winding directions of coils of half of the two transmission devices connected by a conductive wire are opposite.

### CROSS-REFERENCE TO RELATED APPLICATION(S)

This application claims priority from Korean Patent Application No. 10-2015-0169408, filed on Nov. 30, 2015 and Korean Patent Application No. 10-2016-0143583, filed on Oct. 31, 2016 in the Korean Intellectual Property Office, the disclosure of which is incorporated herein by reference in its entirety.

### BACKGROUND

1. Field

The following description relates to wireless power transmission, and more particularly, to technology for implementing an in-phase power feeding method without dual loops using an open type resonance coil.

2. Description of Related Art

In wireless power transmission technology, a transmission and reception resonator is largely classified into an indirect power feeding resonator and a direct power feeding resonator. Here, the indirect power feeding resonator has a structure in which a resonance coil and a power feeding coil are separated from each other, and the direct power feeding resonator has a structure for directly feeding power to the resonance coil.

The coaxial cable of the direct power feeding resonator is classified into a closed type coaxial coil having a closed type structure in which ends of a conductive wire of the coaxial cable are connected to each other like a loop, and an open type coaxial coil in which ends of the conductive wire of the coaxial cable are open to each other like a spiral structure.

The open type coaxial coil having one spiral or a multi-spiral shape may be manufactured. When performing in-phase power feeding using a conventional open type coaxial coil for direct power feeding having this structure, technology for increasing a transmission region having high power transmission efficiency is not provided even when the impedance is fixed. However, it is very important to increase the transmission region to have the high power transmission efficiency in the wireless power transmission technology. The reason is that a great degree of freedom of a power transmission receiver is provided, a plurality of reception coils are accommodated, and a problem in which the power transmission efficiency is decreased is improved according to a position error of the reception coil.

A conventional art for solving the problem is a parallel type in-phase power feeding method with dual loops, and is the wireless power transmission technology for an indirect power feeding system configured as a power feeding loop and a resonator. There is a problem in which the indirect power feeding method is difficult to apply to various types of thin devices such as a mobile phone since an interval between a loop and a resonator is present.

One among methods for solving the problem is a method of directly feeding power to the resonator. That is, in order to feed power in a parallel type and feed the power in-phase so that a direction of a magnetic flux is matched in the center, transmission lines connected between parallel points and resonators are designed to be the same and winding directions of the resonators are designed to be in-phase. However, when manufacturing the resonators according to the method, the transmission efficiency is abruptly decreased in the center.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The following description relates to an open type coaxial resonance coil without dual loops having a serial type in-phase direct power feeding method without dual loops which has high transmission efficiency and provides a wide transmission region.

In one general aspect, a transmitter, includes: at least two transmission devices configured to radiate wireless energy into space using an in-phase direct power feeding method, and connected in series; a radio frequency (RF) signal generator configured to generate a wireless signal; a power amplifier configured to amplify the wireless signal generated by the RF signal generator; an impedance matching unit configured to increase energy transmission efficiency of the wireless signal amplified by the power amplifier, and transmit the wireless signal through the transmission devices; and a main control unit (MCU) configured to control the RF signal generator to generate the wireless signal of by exchanging information with a receiver.

In another general aspect, a receiver, includes: a reception device configured to receive wireless energy from space in a direct power feeding method; an alternating current (AC)/direct current (DC) converter configured to convert the wireless energy of the received AC signal into a DC signal so that a load uses the wireless energy of the received AC signal; an impedance matching unit configured to improve wireless energy transmission efficiency of the reception device; and a main control unit (MCU) configured to control the reception device to generate the wireless signal by exchanging information with a transmitter.

Other features and aspects will be apparent from the following detailed description, the drawings, and the claims.

### BRIEF DESCRIPTION OF THE DRAWINGS

FIG. 1 is a diagram illustrating a wireless power transmission system for a general parallel type in-phase power feeding method with dual loops.

FIG. 2 is a diagram for describing a concept of a general parallel type in-phase power feeding method with dual loops.

FIG. 3 is a graph illustrating a characteristic of an S12 parameter according to a position of a reception coil when using a general parallel type in-phase power feeding method with dual loops.

FIG. 4 is a diagram illustrating an example of a wireless power transmission system using a parallel type in-phase direct power feeding method without dual loops.

FIG. 5 is a diagram for describing a concept of a parallel type in-phase direct power feeding method without dual loops.

FIG. 6 is a graph illustrating a characteristic of an S12 parameter according to a position of a reception coil when using a parallel type in-phase direct power feeding method without dual loops.

FIG. 7 is a diagram illustrating a configuration of a wireless power transmission system using a serial type in-phase direct power feeding method without dual loops according to an embodiment of the present invention.

FIG. 8 is a diagram for describing a concept of a serial type in-phase direct power feeding method without dual loops according to one embodiment of the present invention.

FIG. 9 is a graph illustrating a characteristic of an S12 parameter according to a position of a reception coil when using a serial type in-phase direct power feeding method without dual loops according to one embodiment of the present invention.

FIG. 10 is a diagram illustrating a configuration of a wireless power transmission system using a serial type in-phase direct power feeding method without dual loops according to another embodiment of the present invention.

FIG. 11 is a diagram illustrating a configuration of a wireless power transmission system using a serial type in-phase direct power feeding method without dual loops according to still another embodiment of the present invention.

FIG. 12 is a diagram illustrating a configuration of a wireless power transmission system using a serial type in-phase direct power feeding method without dual loops according to yet another embodiment of the present invention.

FIG. 13 is a diagram illustrating a configuration of a wireless power transmission system using a serial type in-phase direct power feeding method without dual loops according to yet another embodiment of the present invention.

FIG. 14 is a diagram illustrating a configuration of a wireless power transmission system using a serial type in-phase direct power feeding method without dual loops according to yet another embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

Hereinafter, embodiments of the present invention will be described in detail with reference to the accompanying drawings to enable those of ordinary skill in the art to implement the present invention. However, the present invention may be implemented in many alternate forms, and should not be construed as limited to the embodiments set forth herein.

Further, in order to clearly describe the present invention, a portion which is not related to the description will be omitted, and throughout the specification, like reference numerals refer to like components.

Throughout the specification, when one component “comprises”, “includes”, or “has” another component, unless otherwise defined, it means that one or other components are not precluded but further included.

Hereinafter, a wireless power transmission system using an open type resonance coil without dual loops having a serial type in-phase indirect power feeding method without dual loops will be described with reference to the accompanying drawings.

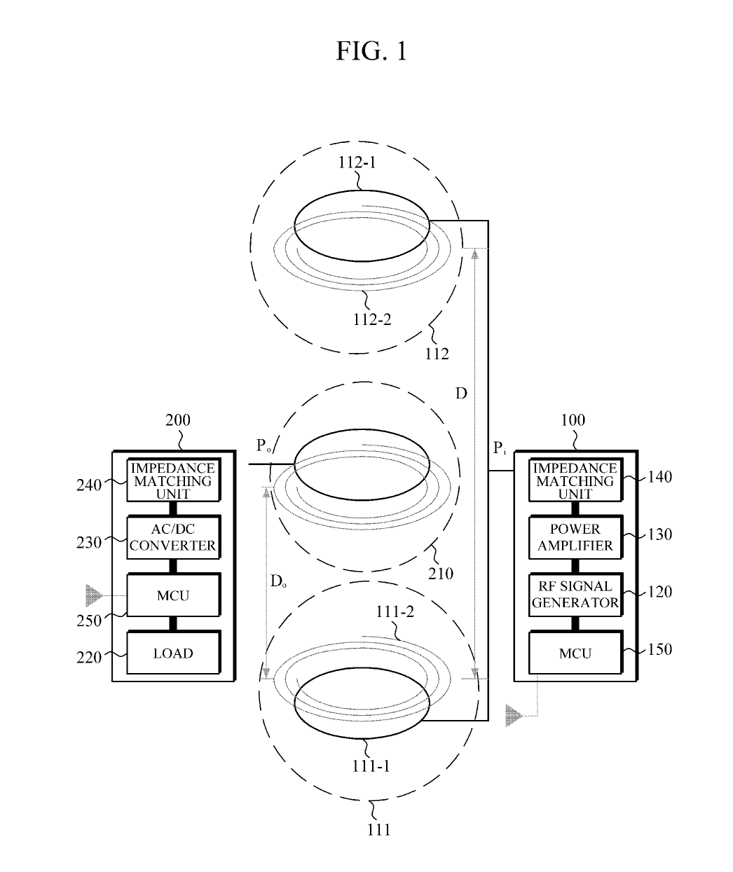

FIG. 1 is a diagram illustrating a wireless power transmission system for a general parallel type in-phase power feeding method with dual loops.

Referring to FIG. 1, generally, a wireless power transmission system may include a transmitter 100 and a receiver 200.

The transmitter 100 may include transmission devices 111 and 112, a radio frequency (RF) signal generator 120, a power amplifier 130, an impedance matching unit 140, and a main control unit (MCU) 150.

The transmission devices 111 and 112 may radiate wireless energy into space. The RF signal generator 120 may generate a wireless signal, and the power amplifier 130 may amplify the generated wireless signal. The impedance matching unit 140 may increase energy transmission efficiency of the wireless signal amplified by the power amplifier 130, and transmit the amplified wireless signal through the transmission devices 111 and 112. The impedance matching unit 140 may generally include well-known devices such as a variable capacitor or a parallel type capacitor, and an inductance circuit, etc. The MCU 150 may control the RF signal generator 120 to generate the wireless signal by exchanging information regarding whether power is correctly transmitted or how much power is needed, etc. with the receiver 200.

The receiver 200 may include a reception device 210, a load 220, an alternating current (AC)/a direct current (DC) converter 230, an impedance matching unit 240, and an MCU 250.

The reception device 210 may receive wireless energy from space. The load 220 may use the received power. The AC/DC converter 230 may convert the wireless energy of the received AC signal into a DC signal so that the load 220 uses the wireless energy of the received AC signal. The impedance matching unit 240 may increase wireless energy transmission efficiency of the reception device 210. The impedance matching unit 240 may generally include well-known devices such as a variable capacitor or a parallel type capacitor, and an inductance circuit, etc. The MCU 250 may control components of the receiver 200 by exchanging information between the transmitter and the receiver by receiving information transmitted from the transmitter 100, or transmitting needed information to the transmitter 100, etc. Hereinafter, since an internal configuration and a description of the transmitter 100 and the receiver 200 are the same as described above with reference to FIG. 1, a detailed description thereof will be omitted.

In the wireless power transmission system, the transmission and reception resonance coil (it may be referred to as a “resonator”) used in transmission and reception devices 111, 112, and 210 may be largely classified into two types according to a power feeding method. As shown in FIG. 1, there may be a loop power feeding coil for feeding power with loops 111-1 and 112-1 and a direct power feeding coil for directly feeding power without loops, and the direct power feeding coil may be classified into a symmetric power feeding coil and an asymmetric power feeding coil.

When using the direct power feeding coil, an object of the present invention is to provide high power efficiency and obtain a wide reception region in which a change width of an impedance matching is small as shown in FIG. 1.

Referring to FIG. 1, two transmission resonance coils 111 and 112 may be included, and located at both sides of a reception resonance coil 210 as a center. The transmission resonance coils 111 and 112 may include power feeding loops 111-1 and 112-1, and resonance coils 111-2 and 112-2, and the power feeding loops 111-1 and 112-1 may be fed so that the power provided from the transmitter 100 is transmitted.

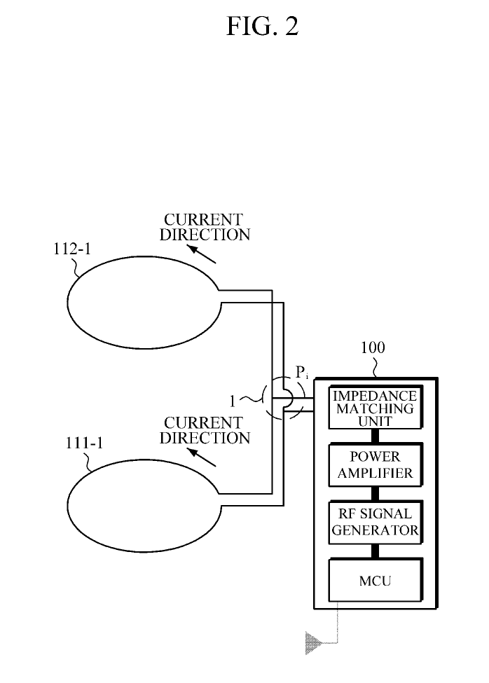

FIG. 2 is a diagram for describing a concept of a general parallel type in-phase power feeding method with dual loops.

Referring to FIG. 2, the power transmitted from the transmitter 100 may be connected in parallel, distances which are from a parallel point 1 to the power feeding loops 111-1 and 112-1 may be connected to be equal, directions of currents in the facing power feeding loops 111-1 and 112-1 may be the same, and thus a concept in which a much greater reception region is secured may be implemented by applying a principle in which an in-phase magnetic field is formed in the center.

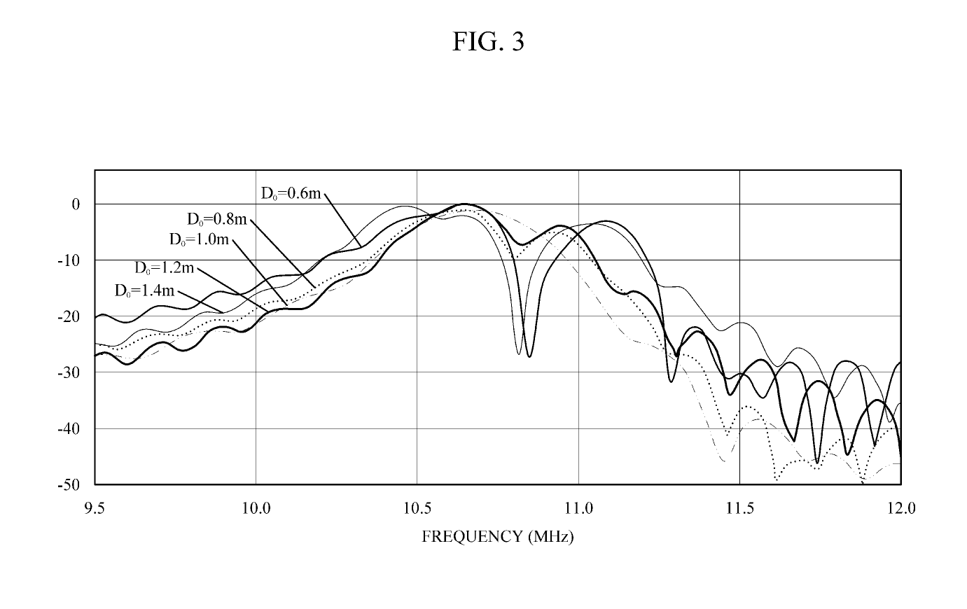

FIG. 3 is a graph illustrating a characteristic of an S12 parameter according to a position of a reception coil when using a general parallel type in-phase power feeding method with dual loops.

Referring to FIG. 3, a characteristic of an S12 parameter according to a distance D between the reception resonator and the transmission resonator is illustrated. When implementing the wireless power transmission system using a parallel type in-phase power feeding method with dual loops, there may be an advantage in which reception power efficiency of the reception resonator located between the transmission resonators is improved, and also a wide reception region is secured. It is well known that the parallel type has a wider reception region and better impedance matching than the serial type.

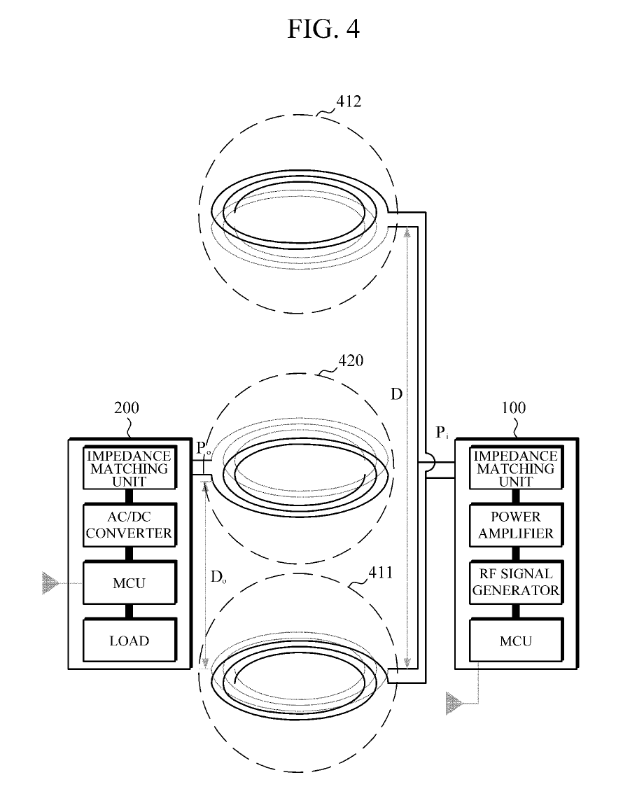

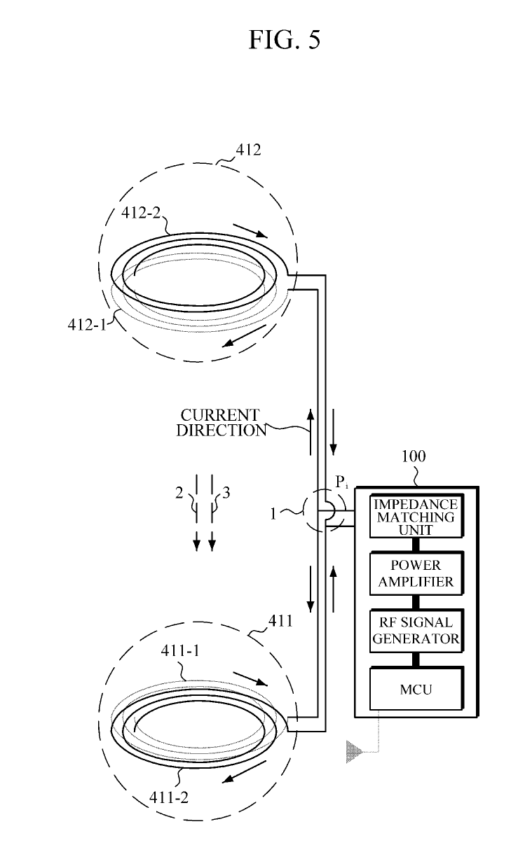

Meanwhile, the wireless power transmission system using the parallel type in-phase direct power feeding method without dual loops may be implemented as shown in FIGS. 4 and 5 by applying the parallel type in-phase power feeding method with the dual loops described above to the direct power feeding method.

FIG. 4 is a diagram illustrating an example of a wireless power transmission system using a parallel type in-phase direct power feeding method without dual loops.

Referring to FIG. 4, the transmission and reception devices 111, 112, and 210 having the indirect power feeding method shown in FIG. 1 may be changed into transmission and reception devices 411, 412, and 420 having the direct power feeding method.

FIG. 5 is a diagram for describing a concept of a parallel type in-phase direct power feeding method without dual loops.

Referring to FIG. 5, parallel type power feeding may be performed like the method shown in FIG. 2, the transmission lines connected between the parallel point 1 and the transmission devices 411 and 412 may be identical to feed power in phase in which directions 2 and 3 of magnetic fluxes are the same in the center. Further, it is possible to design by considering coil winding directions of the transmission devices 411 and 412.

That is, directions of currents induced in the facing transmission devices 411 and 412 may be the same so that current directions of the transmission lines connected to the transmitter 100 are formed and the directions 2 and 3 of the magnetic fluxes are the same in the center. Since the directions of the magnetic fluxes generated in the transmission devices 411 and 412 are the same in the center and in-phase, the magnetic field may be increased twofold. Accordingly, the parallel type in-phase direct power feeding method without dual loops capable of achieving the same effect as the parallel type in-phase loop power feeding method with dual loops described above may be implemented. However, in the parallel type in-phase direct power feeding method without dual loops, the transmission efficiency may be abruptly decreased in the center.

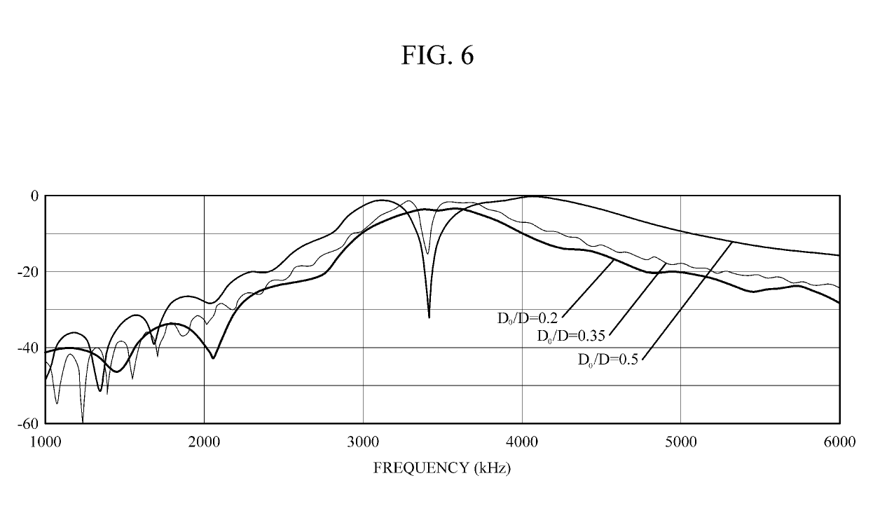

FIG. 6 is a graph illustrating a characteristic of an S12 parameter according to a position of a reception coil when using a parallel type in-phase direct power feeding method without dual loops.

Referring to FIG. 6, the transmission efficiency may be abruptly decreased in the center. Winding directions of the resonance coils 411-1 and 412-1 connected to the current transmission lines which are directed toward the outside from the parallel point 1 shown in FIG. 5 may be wound in the same direction, and installed to face each other. The resonance coils 411-2 and 412-2 connected to the current transmission lines which are directed toward the parallel point 1 may also be wound in the same direction, and installed to face each other. A subsequent current may be formed to flow in a direction of suppressing resonance since each of the resonance coils 411-1 and 412-1 has a structure for configuring a separate resonator and the same winding direction, and thus the problem in which the transmission efficiency is decreased in the center may be solved.

Accordingly, in order to solve the problem, the present invention proposes a wireless power transmission system using a serial type in-phase direct power feeding method without dual loops.

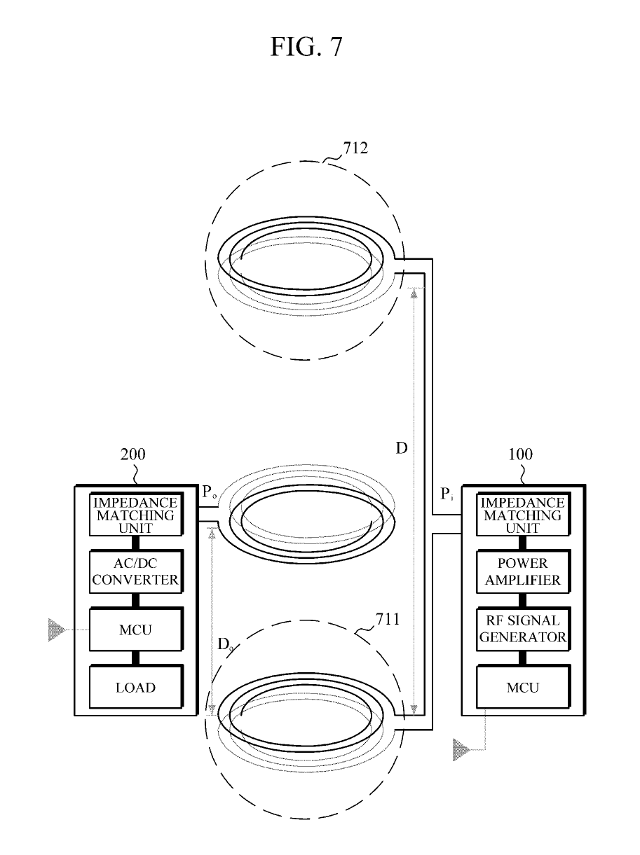

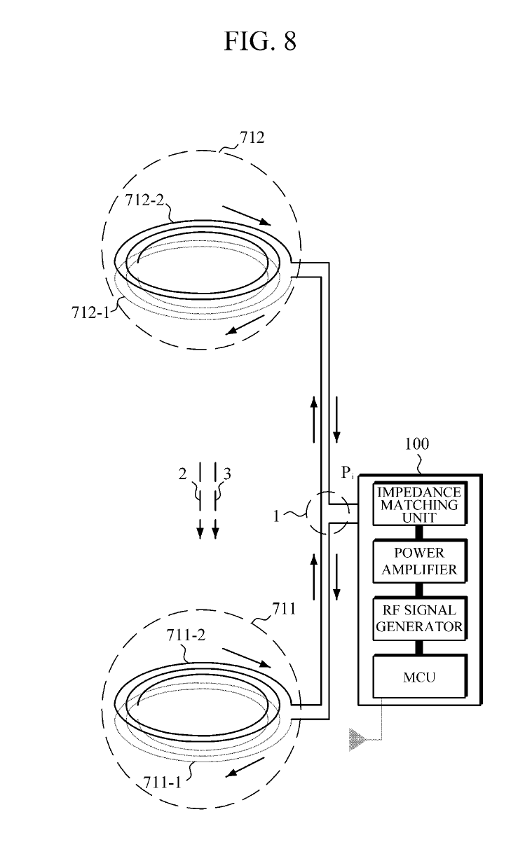

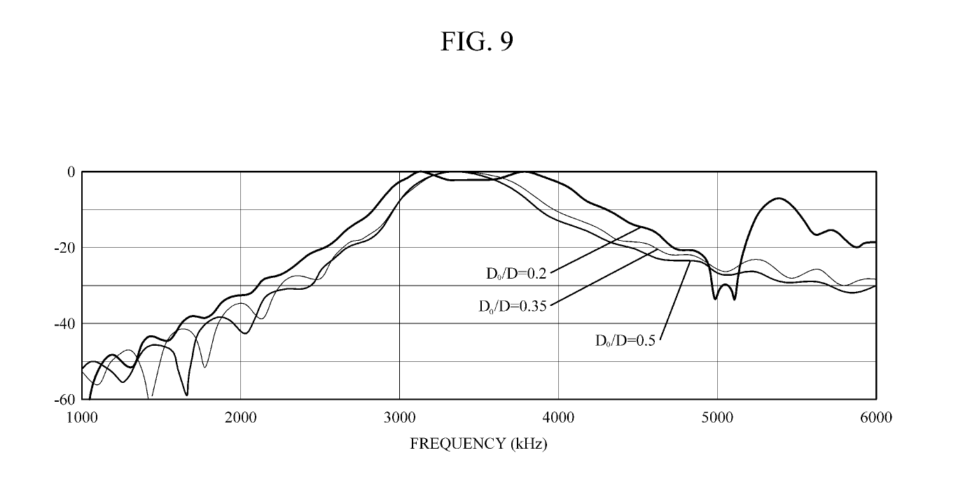

FIG. 7 is a diagram illustrating a configuration of a wireless power transmission system using a serial type in-phase direct power feeding method without dual loops according to an embodiment of the present invention, FIG. 8 is a diagram for describing a concept of a wireless power transmission system using a serial type in-phase direct power feeding method without dual loops according to one embodiment of the present invention, and FIG. 9 is a graph illustrating a characteristic of an S12 parameter according to a position of a reception coil when using a serial type in-phase direct power feeding method without dual loops according to one embodiment of the present invention.

Referring to FIGS. 7 and 8, winding directions of the resonance coils 711-1, 711-2, 712-1, and 712-2 are opposite, and referring to FIG. 8, a structure of connecting in series to maintain in-phase in the center 1 is illustrated.

Referring to FIG. 9, it may be confirmed that impedance matching may be performed in entire region including the center, and the transmission efficiency is 90% or more.

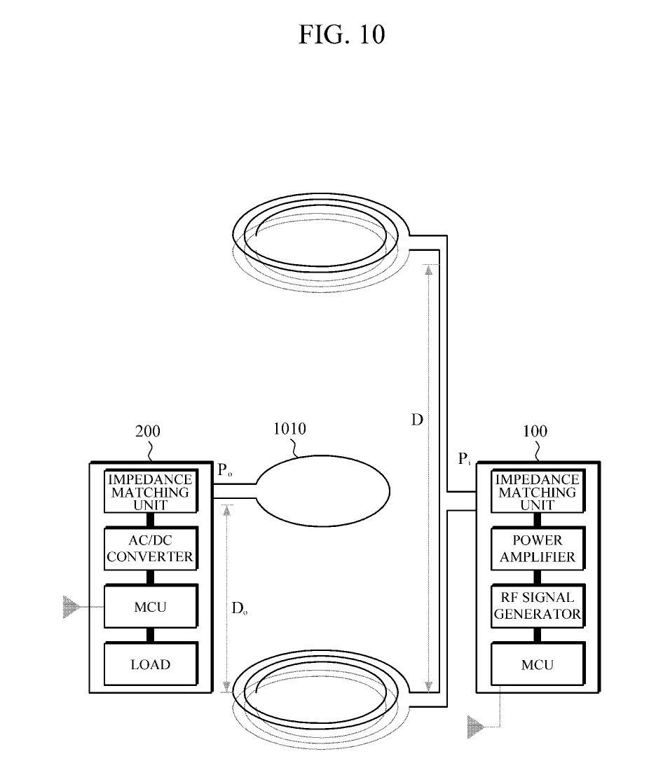

FIG. 10 is a diagram illustrating a configuration of a wireless power transmission system using a serial type in-phase direct power feeding method without dual loops according to another embodiment of the present invention.

Referring to FIG. 10, as shown in FIG. 7, transmission devices 1011 and 1012 having a direct power feeding method may be connected in series, and a reception device 1010 may be configured to have a one-turn loop. It can be seen that this structure has an advantage of providing a wide reception region.

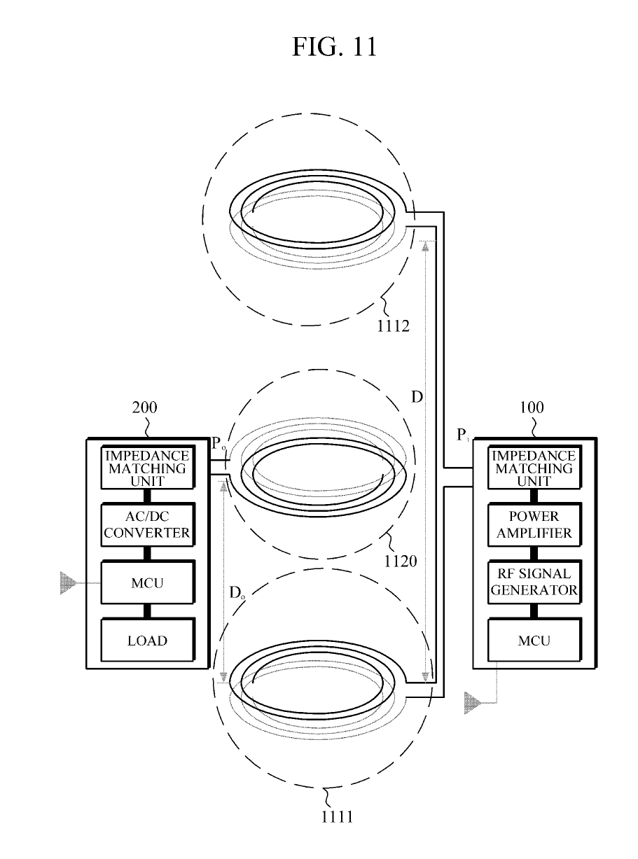

FIG. 11 is a diagram illustrating a configuration of a wireless power transmission system using a serial type in-phase direct power feeding method without dual loops according to still another embodiment of the present invention.

Referring to FIG. 11, it can be seen that it is possible to exchange functions of the transmission resonance coil and the reception resonance coil shown in FIG. 7.

This relationship may be applied to the method shown in FIG. 10. When the relationship is applied to FIG. 10, a structure having a less effect on a human body may be formed due to a small electric field and magnetic field which are directed toward the outside since a non-resonant loop is located outside. A separate drawing was not added, but the same effect may be obtained when applying the same principle as the symmetric direct power feeding to the asymmetric direct power feeding. This technology may have a structure capable of being applied even when including a plurality of receivers.

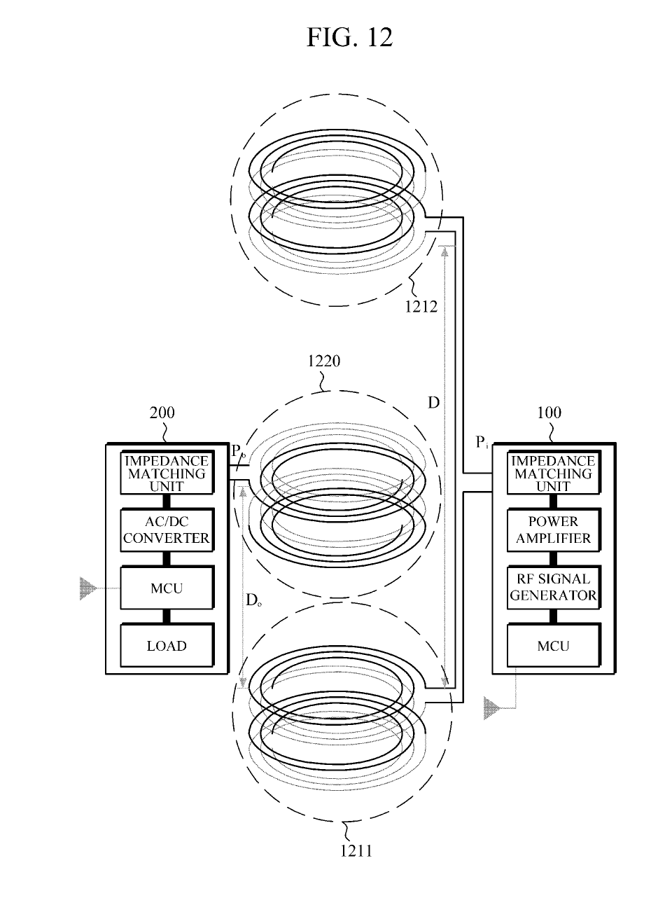

FIG. 12 is a diagram illustrating a configuration of a wireless power transmission system using a serial type in-phase direct power feeding method without dual loops according to yet another embodiment of the present invention.

Referring to FIG. 12, an example in which a resonance coil having a short circuit structure is installed to be adjacent to a transmission and reception resonance coil is illustrated, and in this case, a much greater transmission distance may be secured. The reason is that more magnetic field energy is formed around the resonator. In this structure, the resonance coil having the short circuit structure may be installed as it is as the transmission resonator, and the reception resonator may not be installed. That is, since various reception resonance coils are applied, applicability may be increased. Further, in this structure, the same characteristic may be obtained even when a plurality of resonance coils having the short circuit structure are arranged and installed.

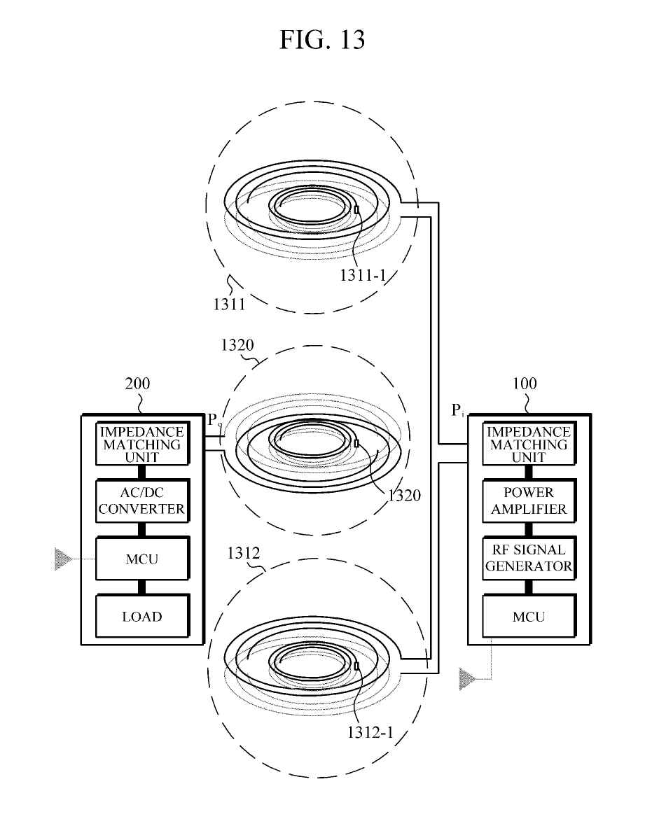

FIG. 13 is a diagram illustrating a configuration of a wireless power transmission system using a serial type in-phase power feeding method without dual loops according to yet another embodiment of the present invention.

Referring to FIG. 13, a much greater transmission distance may be secured like the characteristic shown in FIG. 12. In order to adjust a resonant frequency and perform impedance matching in this structure, a capacitor may be connected to a point 15 in series or a short circuit structure as shown in FIG. 12 may be connected. When connecting the short circuit structure, the same effect according to the present invention may be obtained when the adjustment of the resonant frequency is performed and the impedance matching is achieved by adjusting a length of a line and an interval between lines of the resonator installed inside.

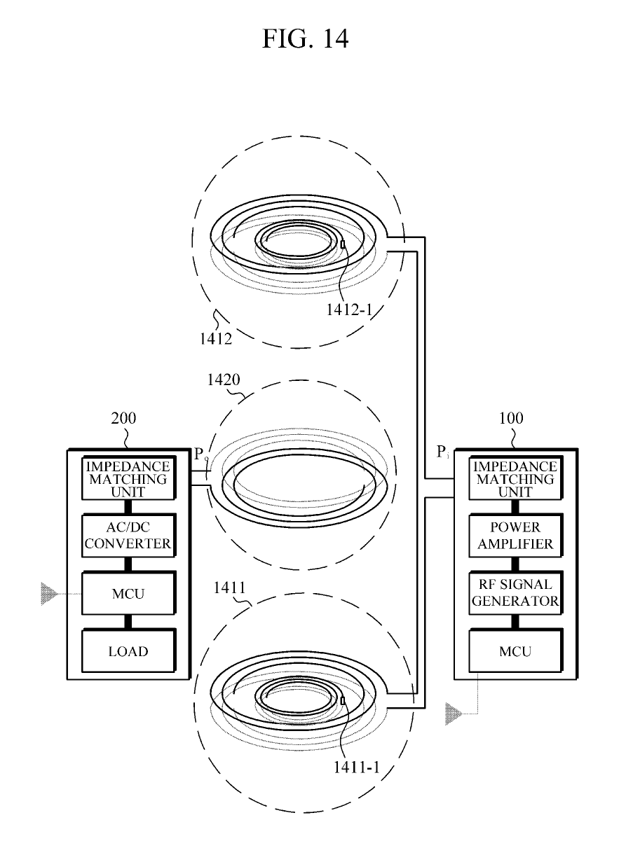

FIG. 14 is a diagram illustrating a configuration of a wireless power transmission system using a serial type in-phase direct power feeding method without dual loops according to yet another embodiment of the present invention.

Since the impedance matching is possible using a conventional impedance matching circuit configured by a capacitor and an inductor located at the receiver, the reception resonator having a simple structure and a low cost may be manufactured unlike FIG. 13, and it may be available as a charging device for a receiver having a single resonator in various mobile phones charger, an Internet of things (IoT) device charger, a robot charger, etc. The same effect may be obtained even when two or more resonators are installed inside.

Embodiments of the present invention may not be implemented through only the devices and/or methods described above, and while the present invention is described with reference to the above-described embodiments, the scope of the present invention is not limited to the above-described embodiments, and includes various alternatives and modifications by those of ordinary skill in the art using a basic concept of the present invention.

What is claimed is:

1. A transmitter, comprising:
at least two transmission devices configured to radiate wireless energy into space using an in-phase direct power feeding method, and connected in series;
a radio frequency (RF) signal generator configured to generate a wireless signal;
a power amplifier configured to amplify the wireless signal generated by the RF signal generator;
an impedance matching unit configured to increase energy transmission efficiency of the wireless signal amplified by the power amplifier, and transmit the wireless signal through the transmission devices; and
a main control unit (MCU) configured to control the RF signal generator to generate the wireless signal by exchanging information with a receiver.

2. The transmitter of claim 1, wherein the transmission devices are configured as a power feeding loop without a resonance coil.

3. The transmitter of claim 1, wherein the transmission devices include two coils having a short circuit structure, and winding directions of the two coils are opposite.

4. The transmitter of claim 1, wherein the transmission devices include two or more resonance coils having a short circuit structure, and the two or more resonance coils are arranged to be adjacent to each other.

5. The transmitter of claim 4, wherein the resonance coils are arranged to be in parallel above and below.

6. The transmitter of claim 4, wherein the resonance coils are arranged to be horizontal inside and outside.

7. The transmitter of claim 6, wherein the resonance coils have a structure in which a capacitor is connected to the resonance coil located inside.

8. A receiver, comprising:
a reception device configured to receive wireless energy from space in a direct power feeding method;
an alternating current (AC)/direct current (DC) converter configured to convert the wireless energy of the received AC signal into a DC signal so that a load uses the wireless energy of the received AC signal;
an impedance matching unit configured to improve wireless energy transmission efficiency of the reception device; and
a main control unit (MCU) configured to control the reception device to generate the wireless signal by exchanging information with a transmitter.

9. The receiver of claim 8, wherein the reception device is configured as a power feeding loop without a resonance coil.

10. The receiver of claim 8, wherein the reception device includes two or more resonance coils having a short circuit structure, and the two or more resonance coils are arranged to be adjacent to each other.

11. The receiver of claim 10, wherein the resonance coils are arranged to be in parallel above and below.

12. The receiver of claim 10, wherein the resonance coils are arranged to be horizontal inside and outside.

13. The receiver of claim 12, wherein the resonance coils have a structure in which a capacitor is connected to the resonance coil located inside.

14. The receiver of claim 8, wherein the reception device is a one-turn loop.
